(19) United States
(12) Patent Application Publication
(10) Pub. No.: US 2026/0084992 A1
(43) Pub. Date: Mar. 26, 2026

(54) SATURATED WATER GENERATION DEVICE

(71) Applicants: Tsuyoshi IMAI, Yamaguchi (JP); Tetsuhiko FUJISATO, Yamaguchi (JP); Shouta FUJISATO, Yamaguchi (JP); Ubekogyo Co., Ltd., Yamaguchi (JP); KAGAWA EDUCATIONAL INSTITUTION, Yamaguchi (JP); BUBBLETANK Co., Ltd., Yamaguchi (JP); Earth Creative Co., Ltd., Yamaguchi (JP); ISHIGAKI COMPANY LIMITED, Tokyo (JP)

(72) Inventors: Tsuyoshi IMAI, Yamaguchi (JP); Tetsuhiko FUJISATO, Yamaguchi (JP); Shouta FUJISATO, Yamaguchi (JP)

(21) Appl. No.: 18/892,637

(22) Filed: Sep. 23, 2024

(51) Int. Cl. C02F 7/00

(52) U.S. Cl. CPC C02F 7/00; C02F 2209/225

(57) ABSTRACT

A saturated water generation device includes: a container in which an upper surface is open and a bottom surface and side surfaces are closed by a bottom plate and four side plates each having a rectangular shape in plan view; a water guide plate which is bent so as to form a shape in which an ovoid line in a side view is partially cut out, and is installed inside the container with an opening (a portion sandwiched between a pair of ends) facing upward; a nozzle that ejects water from above to an inner surface near the opening; a water supply pipe having a distal end to which the nozzle is connected; a water supply pump whose discharge port is connected to a proximal end of the water supply pipe; and an overflow pipe connected to a first drain port provided in the side plate near the bottom plate.

### TECHNICAL FIELD

The present invention relates to a device that is installed in a lake, a marsh, an aquaculture farm of seafood, a sewage treatment plant, or the like to generate water (saturated water) in which the amount of dissolved oxygen reaches a saturated state, and particularly relates to a saturated water generation device capable of efficiently generating saturated water with a simple structure.

### DESCRIPTION OF THE RELATED ART

Organic sludge present in a benthic region of a pond, a swamp, or the like is decomposed by microorganisms. However, if the amount of dissolved oxygen in water is small, the organic sludge is anaerobically decomposed, and as a result, sulfides, methane gas, and the like are generated. In order to prevent generation of these harmful substances, a technique for increasing the amount of dissolved oxygen in water is required, and some inventions and schemes have already been disclosed regarding the technique.

For example, Patent Literature 1 discloses an invention related to a device installed in water for the purpose of improving water quality by supplying oxygen to an oxygen-deficient zone under the name of “oxygen supply device for water”.

The invention disclosed in Patent Literature 1 has a structure including a dissolving tank that is installed in water and discharges obtained oxygen dissolved water to any depth of water layer, a pump that sucks water in any depth of water layer and supplies the water to the dissolving tank, a gas injection means for injecting a gas containing oxygen into pumped water on a suction side and a discharge side of the pump, and a floating body disposed on a water surface of a lake or the like in a state where the pump is installed.

According to such a structure, since the pump is installed near an upper portion of the dissolving tank installed in the water, the pressure of the dissolving tank can be increased using the water pressure, and the undissolved gas is refluxed to the gas injection means, so that the effective use of the gas can be promoted.

In addition, Patent Literature 2 discloses an invention related to a device capable of reliably performing emergency exhaust by an emergency exhaust pipe without being affected by a differential pressure between the inside and outside of an aerator main body or a floating material under the name of “deep aeration device”.

The invention disclosed in Patent Literature 2 includes the aerator main body that is held at a benthic region of a dam lake or the like and circulates deep water near the benthic region by aeration, an exhaust pipe and the emergency exhaust pipe installed in an upper portion of the aerator main body, a float valve installed at a lower end opening of the emergency exhaust pipe to move up and down in accordance with a variation of a water level in the aeration body, and has a structure in which the emergency exhaust pipe has an upper end opening provided near the outside of the aerator main body and the lower end opening provided below a lower end opening of the exhaust pipe and below the normal water level of an air reservoir in the aerator main body, and the float valve closes the lower end opening of the emergency exhaust pipe by buoyancy at a normal time when the water level is higher than a height of the lower end opening of the emergency exhaust pipe, and opens the lower end opening of the emergency exhaust pipe in emergency in which the water level is lower than the height of the lower end opening of the emergency exhaust pipe.

The invention disclosed in Patent Literature 2 does not have a structure in which a valve is opened and closed depending on the differential pressure between the inside and the outside, but has the structure in which the float valve in the aerator main body is opened and closed depending on the rise and drop of the water level, and thus it is not necessary to adjust the opening and closing pressure. Therefore, the emergency exhaust can be reliably performed. In addition, since the float valve is disposed in the aerator main body, there is no possibility that an operating portion is clogged with a floating material of muddy sand or a floating material such as a fallen leave or a plastic bag blocks an opening of the valve, so that the emergency exhaust can be reliably performed.

Furthermore, Patent Literature 3 discloses an invention related to a device that is installed in a water tank of a wastewater treatment facility or the like and aerates water in the water tank while stirring the water under the name of “submersible stirring aeration device”.

The invention disclosed in Patent Literature 3 includes a rotary cone that has a bowl-like shape spreading downward and has an opening facing downward, a compressed air chamber formed inside the rotary cone, and a disk-shaped a bottom rectifying plate having a flat plate-shaped upper surface and disposed below the rotary cone, and has a structure in which a vertical gap between a lower end of a peripheral edge portion of the opening of the rotary cone and an upper surface of the bottom rectifying plate, and a large number of narrow slits formed over the entire periphery of the peripheral edge portion of the opening of the rotary cone are used as outlets for compressed air stored in the compressed air chamber.

According to such a structure, a large amount of fine air bubbles sheared by a rotational force of the rotary cone is generated, a contact area with water increases, and the oxygen dissolving efficiency is improved.

### CITATION LIST

### Patent Literatures

Patent Literature 1: JP 2005-230713 A
Patent Literature 2: JP 2012-61423 A
Patent Literature 3: Japanese Patent No. 6600779

### SUMMARY OF THE INVENTION

### Problems to be Solved by the Invention

The invention disclosed in Patent Literature 1 has a structure in which water into which oxygen has been injected by the gas injection means is supplied into the dissolving tank, but a dissolved oxygen concentration of water cannot be sufficiently increased with such a structure. In addition, FIG. 1 and the specification describe that water which has been ejected from a nozzle into the dissolving tank and collided with a baffle plate vigorously bubbles to increase a gas-liquid contact surface area as a first embodiment, but it is difficult to increase the dissolved oxygen concentration also by bubbling the water into which oxygen has been injected.

In addition, the invention disclosed in Patent Literature 2 has the effect of reliably performing the emergency exhaust, but the dissolved oxygen concentration of water cannot be efficiently increased only by aeration by an air diffuser tube.

Furthermore, the invention disclosed in Patent Literature 3 has a structure in which a large amount of minute air bubbles are generated and diffused, but it is difficult to sufficiently increase the dissolved oxygen concentration of water by a method of generating fine bubbles.

The present invention has been made in view of such conventional circumstances, and an object thereof is to provide a saturated water generation device capable of efficiently generating water saturated with oxygen in a lake, a marsh, an aquaculture farm of seafood, a sewage treatment plant, or the like with a simple structure to sufficiently increase a dissolved oxygen concentration of water.

### Means for Solving the Problem

In order to achieve the above object, a saturated water generation device according to a first invention includes: a container in which a bottom surface and a side surface are closed, a first drain port through which treated water is discharged is provided in a lower portion, and a gas phase is formed in an upper portion by a gas containing at least oxygen; a water guide member that is installed in the container with an opening facing upward and has an inner surface whose contour line has a shape in which an ovoid line is partially cut out in a side view of the inner surface continuous with the opening; a nozzle configured to eject water from above to the inner surface near the opening; a water supply pipe having a distal end to which the nozzle is connected; and a water supply pump having a discharge port connected to a proximal end of the water supply pipe, in which the treated water is stored in the lower portion of the container.

Note that an ovoid line is also called a closed convex curve, and is defined as a single closed curve on a plane such that all points on line segments each connecting any two points inside the ovoid line are inside the ovoid line. The ovoid line in the first invention includes a substantially ovoid line in which a part of the curve is replaced with a straight line.

In the first invention, when water is ejected from the nozzle toward the inner surface near the opening with respect to the water guide member, the water flows downward along the inner surface of the water guide member while entraining the gas forming the gas phase in the upper portion of the container, and then, is reversed at the lowermost portion of the inner surface, and flows upward along the inner surface of the water guide member again. Thereafter, water and air bubbles that have reached the vicinity of the opening of the water guide member are partially pushed into the lower side of the water guide member by water ejected from the nozzle, and the rest overflows from the opening of the water guide member. Then, the water and the air bubbles pushed into the lower side of the water guide member flow downward along the inner surface of the water guide member while entraining the above-described gas again, and then are reversed to flow upward at the lowermost portion, and are divided into water and air bubbles to be pushed into the lower side of the water guide member again by water ejected from the nozzle, and water and air bubbles to overflow from the water guide member near the opening.

As described above, in the first invention, as the water ejected from the nozzle repeats to flow downward and upward along the inner surface of the water guide member many times while entraining the gas containing oxygen, the inside of the water guide member is filled with the air bubbles. This causes more and more oxygen contained in the air to be dissolved in the water, and as a result, there is an effect that water (saturated water) in which the amount of dissolved oxygen finally reaches a saturated state is generated. In addition, there is an effect that the saturated water that has been generated inside the water guide member, overflowed from the opening, and moved downward of the water guide member is discharged as the treated water from the first drain port to the outside of the container.

According to a second invention, in the first invention, an air supply pipe configured to supply the gas into the container and a compressor connected to a proximal end of the air supply pipe are further provided, the container has an upper surface being closed, and a water supply port, an air supply port, and an openable and closable exhaust port provided in the upper portion, and the distal end of the water supply pipe and a distal end of the air supply pipe are inserted into the container through the water supply port and the air supply port, respectively.

In the second invention, since the upper surface of the container is closed, there is an effect that the gas phase having a pressure higher than an atmospheric pressure is formed in the container by supplying air having a pressure higher than the atmospheric pressure into the container by the compressor, in addition to the effect of the first invention.

According to a third invention, in the second invention, the container is installed to be at least partially immersed in water and has the bottom surface being open instead of being provided with the first drain port, and the water supply pump is a submersible pump.

In the third invention, there are effects that the pressure of the gas phase formed in the container is changed by changing a depth of water at which the container is installed and that a position of a gas-liquid boundary surface is determined by a position of the exhaust port with respect to the container, in addition to the effect of the second invention. In addition, in the third invention, when the gas is continuously supplied from the air supply pipe into the container in a state where the exhaust port is open, the excess gas is discharged from the exhaust port and the gas in the container is constantly exchanged, so that there is an effect that the composition thereof is kept constant.

According to a fourth invention, the third invention is further provided with: a pump pressurizing tank in which the submersible pump is housed, a first water supply channel installed in the water to be parallel to a vertical direction and having a lower end to which the pump pressurizing tank is connected and an upper end being open, a second water supply channel installed in the water to be parallel to a horizontal direction and having one end to which the pump pressurizing tank is connected, and a strainer connected to another end of the second water supply channel.

In the fourth invention, when the submersible pump is operated to supply water into the container through the water supply pipe, the inside of the pump pressurizing tank becomes a negative pressure, so that water inside the first water supply channel moves downward and water inside the second water supply channel moves toward the pump pressurizing tank. When the water inside the second water supply channel moves, water around the strainer is sucked into the second water supply channel. That is, in the fourth invention, the water inside the second water supply channel moves toward the pump pressurizing tank as the water inside the pump pressurizing tank is sucked by the submersible pump, and as a result, there is an effect that the water around the strainer is sucked into the second water supply channel, in addition to the effects of the third invention.

According to a fifth invention, in any one of the first to fourth inventions, the water guide member includes a bent plate material.

The fifth invention has an effect that a structure of the water guide member is simple and a processing cost is low, in addition to the effects of any one of the first invention to the fourth invention.

According to a sixth invention, the first invention is further provided with: a pressurizing tank in which a second drain port through which treated water is discharged is provided in a lower portion and a gas phase is formed in an upper portion by the gas containing at least oxygen and having a pressure higher than an atmospheric pressure, the pressurizing tank being provided instead of the container; an air supply pipe configured to supply the gas into the pressurizing tank; a compressor connected to the air supply pipe; and a drain pipe that is connected to the second drain port and configured to discharge the treated water accumulated in the pressurizing tank, the water guide member being installed in the pressurizing tank with the opening facing upward.

In the sixth invention, since the water guide member is installed inside the pressurizing tank instead of the container, there is an effect that it is easy to form the gas phase having a higher pressure than that in the case of the second invention inside the pressurizing tank and the upper portion in the water guide member, in addition to the effect of the first invention.

According to a seventh invention, in the sixth invention, the water guide member includes a bent plate material and a pair of side plates that closes both side surfaces of the plate material.

In the seventh invention, there is an effect that the structure of the water guide member is simple and a processing cost is low, in addition to the effect of the sixth invention.

### Advantageous Effects of the Invention

According to the first invention, it is possible to efficiently generate water (saturated water) saturated with oxygen and to sufficiently increase a dissolved oxygen concentration of water. In addition, the first invention has a simple structure, and thus can be manufactured at low cost. When the upper surface of the container is open, the pressure of the gas phase formed on the upper surface of the container is equal to the atmospheric pressure, and the container does not need to have a pressure-resistant structure, and thus a manufacturing cost can be further reduced.

According to the second invention, there is an effect that it is possible to generate treated water having a higher dissolved oxygen concentration than that in the case of the first invention in one pass by ejecting water from the nozzle toward the inner surface of the water guide member near the opening in the state where the gas phase having the pressure higher than the atmospheric pressure is formed in the container, in addition to the effect of the first invention.

In the third invention, a control mechanism or the like for keeping the pressure constant is unnecessary since the pressure of the gas phase formed in the container changes depending on the depth of water at which the container is installed, and the sensor for detecting the position of the gas-liquid boundary surface is also unnecessary since the position of the gas-liquid boundary surface is determined by the position of the exhaust port with respect to the container, and thus, there is an effect of reducing the manufacturing cost in addition to the effect of the second invention. In addition, in the third invention, when the gas is continuously supplied from the air supply pipe into the container in the state where the exhaust port is open, the gas in the container is constantly exchanged, and the composition thereof is kept constant, so that there is an effect that a dissolved oxygen concentration of treated water discharged from the container is less likely to vary. Furthermore, since the bottom surface of the container is open and the same water pressure is applied to an inner surface and an outer surface of the container, the container does not need to have a pressure-resistant structure. Therefore, the manufacturing cost is further reduced according to the third invention.

In a case where one end of a pipe for water supply having a strainer attached to the other end is connected to a suction port of the submersible pump, a range in which the strainer can be installed is determined by a suction capacity of the submersible pump. For example, when the suction capacity of the submersible pump is low, the strainer needs to be installed near the submersible pump. On the other hand, in the fourth invention, when the water inside the pump pressurizing tank is sucked by the submersible pump, the water inside the second water supply channel moves toward the pump pressurizing tank, and as a result, the water around the strainer is sucked into the second water supply channel regardless of the suction capacity of the submersible pump.

That is, in the fourth invention, when the pump pressurizing tank and the second water supply channel are installed in a benthic region of a pond, a swamp, or the like, the strainer is installed at a place away from the submersible pump regardless of the suction capacity of the submersible pump, so that there is an effect that a wide range of water can be treated, in addition to the effect of the third invention. At this time, if the container is installed at the same height as the strainer, a temperature difference between bottom water sucked into the second water supply channel from the strainer and treated water discharged from the container is small, and the treated water is hardly mixed with intermediate water and upper water, so that only the water in a bottom water zone can be treated.

According to the fifth invention, since the structure of the water guide member is simple and the processing cost is low, there is an effect that the manufacturing cost is reduced, in addition to the effects of any one of the first to fourth inventions.

According to the sixth invention, there is an effect that treated water having a higher dissolved oxygen concentration than that in the case of the second invention can be generated in one pass by ejecting water from the nozzle toward the inner surface of the water guide member near the opening in the state where the gas phase having the higher pressure than that in the case of the second invention is formed in the pressurizing tank, in addition to the effect of the first invention. In addition, in the sixth invention, since the upper surface of the water guide member is open and the pressure of the gas present inside the water guide member is equal to the pressure of the gas forming the gas phase in the pressurizing tank, the water guide member does not need to have a pressure-resistant structure similar to that of the pressurizing tank. Therefore, according to the sixth invention, it is possible to reduce the manufacturing cost by making the water guide member have a simple structure.

According to the seventh invention, since the structure of the water guide member is simple and the processing cost is low, there is an effect of reducing the manufacturing cost, in addition to the effect of the sixth invention.

### BRIEF DESCRIPTION OF THE DRAWINGS

FIGS. 1(a) and 1(b) are a front view and a side view, respectively, illustrating an appearance of a saturated water generation device according to a first embodiment of the present invention.

FIG. 2(a) is a schematic view for describing an effect of the saturated water generation device illustrated in FIGS. 1(a) and 1(b), and FIG. 2(b) is a front view of a modification of the saturated water generation device.

FIG. 3(a) is an external view of a saturated water generation device according to a second embodiment of the present invention, and FIG. 3(b) is a cross-sectional view taken along line A-A in FIG. 3(a).

FIG. 4(a) is an external perspective view of a water guide member illustrated in FIGS. 3(a) and 3(b), FIG. 4(b) is an external perspective view of a modification of the water guide member, and FIG. 4(c) is a cross-sectional view taken along line B-B in FIG. 4(b).

FIG. 5 is an external view of a saturated water generation device according to a third embodiment of the present invention.

FIG. 6 is an external view of a saturated water generation device according to a fourth embodiment of the present invention.

FIG. 7 is a graph illustrating a relationship between an amount (DO value) of oxygen dissolved in water treated by the saturated water generation device illustrated in FIG. 2(b) and a depth of water.

### DESCRIPTION OF EMBODIMENTS

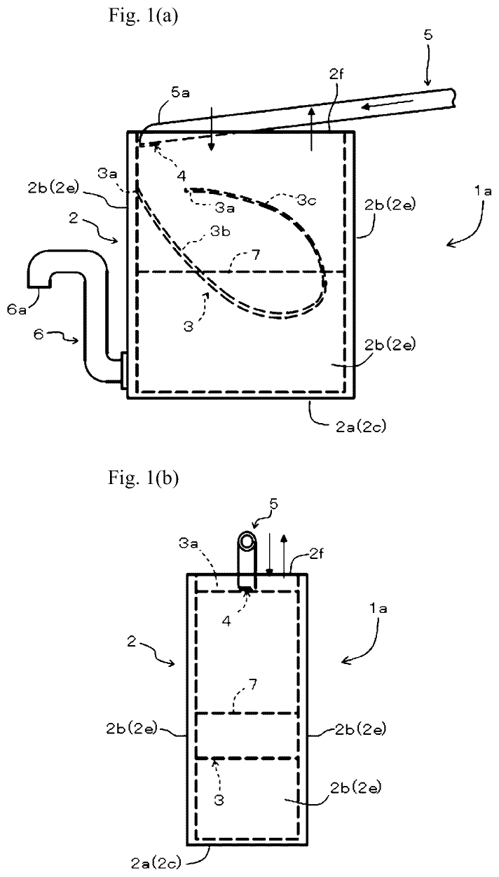

A saturated water generation device of the present invention will be described with reference to FIGS. 1 to 7. In the following description, expressions such as an “upper end”, a “lower end”, a “bottom plate”, and a “bottom surface” are used assuming state where the saturated water generation device is actually installed.

### First Embodiment

FIGS. 1(a) and 1(b) are a front view and a side view, respectively, illustrating an appearance of a saturated water generation device 1a according to a first embodiment of the present invention.

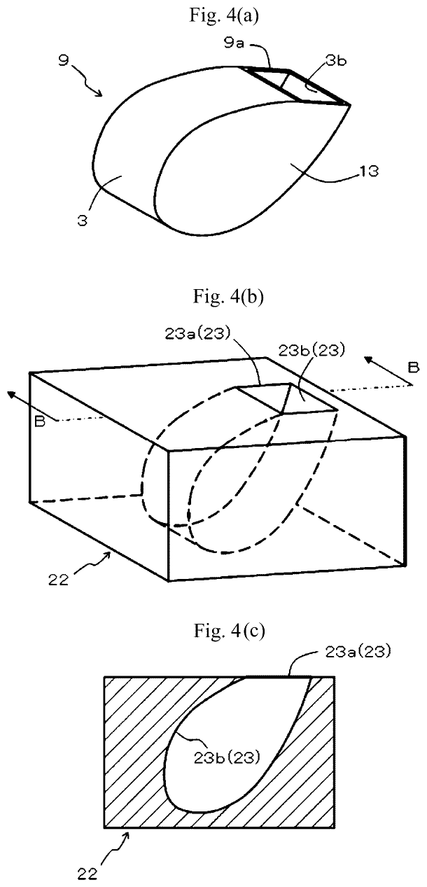

As illustrated in FIGS. 1(a) and 1(b), the saturated water generation device 1a includes: a container 2 in which an upper surface 2f is open and a bottom surface 2c and side surfaces 2e are closed by a bottom plate 2a and four side plates 2b each having a rectangular shape in plan view; a water guide plate 3 which is bent so as to form a shape in which an ovoid line in a side view is partially cut out, and is installed inside the container 2 with an opening (a portion sandwiched between a pair of ends 3a and 3a, and corresponds to an opening 9a illustrated in FIG. 4(a)) facing upward; a nozzle 4 that ejects water from above to an inner surface 3b near the opening; a water supply pipe 5 having a distal end 5a to which the nozzle 4 is connected; a water supply pump (not illustrated) whose discharge port is connected to a proximal end of the water supply pipe 5; and an overflow pipe 6 connected to a first drain port (not illustrated) provided in the side plate 2b near the bottom plate 2a.

Both side surfaces of the water guide plate 3 are closed by a pair of side plates 2b and 2b parallel to each other, and the water guide plate 3 is installed inside the container 2 in a state of being inclined such that one side of the inner surface 3b near the opening to which water is blown by the nozzle 4 faces upward without contact with the side plate 2b far from the opening out of the pair of side plates 2b and 2b perpendicular to the side surfaces. Note that the water guide plate 3 has the inner surface 3b whose contour line has a shape in which an ovoid line is partially cut out in a side view of the inner surface 3b continuous with the above-described opening, but such a cutout part is desirably a portion having the smallest radius of curvature in the ovoid line as illustrated in FIG. 1(a).

As indicated by arrows in FIG. 1(a), the water supplied from the water supply pipe 5 to the nozzle 4 is accumulated in a lower portion of the container 2, but overflows from an open end 6a of the overflow pipe 6 when a gas-liquid boundary surface (water surface 7) reaches a predetermined height. Since the container 2 has the upper surface 2f being open and is in a state where the atmosphere can freely enter and exit the inside, a gas phase is formed in an upper portion of the container 2 (a portion above the gas-liquid boundary surface) by the atmosphere. In the saturated water generation device 1a, the overflow pipe 6 has an effect of maintaining the water surface 7 in the container 2 at a constant height such that the gas phase is formed in the upper portion of the container 2.

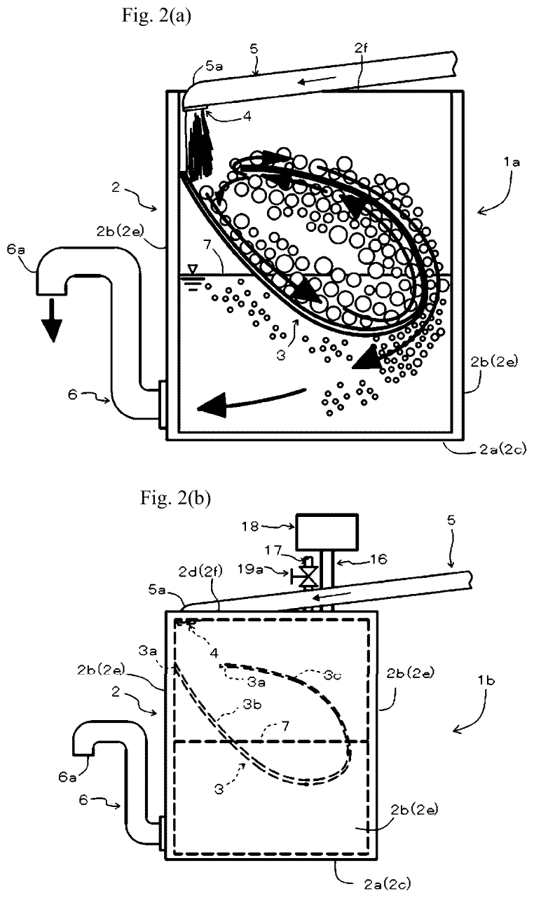

FIG. 2(a) is a schematic view for describing an effect of the saturated water generation device 1a. Note that the side plate 2b disposed in front of the container 2 is not illustrated in FIG. 2(a).

In the saturated water generation device 1a, the water supplied to the nozzle 4 through the inside of the water supply pipe 5 is ejected toward the inner surface 3b near the opening with respect to the water guide plate 3 as indicated by a thin arrow, and flows downward along the inner surface 3b of the water guide plate 3 from the vicinity of one of the pair of ends 3a, 3a (see FIG. 1(a)) as indicated by a thick arrow in FIG. 2(a) while entraining air forming a gas phase in the upper portion of the container 2, and then is reversed at the lowermost portion of inner surface 3b to flow upward along the inner surface 3b again. Thereafter, the water and air bubbles reaching the vicinity of the other of the pair of ends 3a and 3a are partially pushed into the lower side of the water guide plate 3 by water ejected from the nozzle 4, and the rest overflows from the water guide plate 3. Then, the water and air bubbles pushed into the lower side of the water guide plate 3 flow downward along the inner surface 3b while entraining air again, and then are reversed to flow upward at the lowermost portion of the inner surface 3b, and are divided into water and bubbles to be pushed into the lower side of the water guide plate 3 again by water ejected from the nozzle 4 and water and bubbles to overflow from the water guide plate 3 near the opening.

As described above, in the saturated water generation device 1a, the water ejected from the nozzle 4 repeats to flow downward and upward along the inner surface 3b of the water guide plate 3 many times while entraining air forming the gas phase in the upper portion of container 2, whereby the inside of the water guide plate 3 is filled with the air bubbles. This causes more and more oxygen contained in the air to be dissolved in the water, and as a result, water (saturated water) in which the amount of dissolved oxygen finally reaches a saturated state is generated.

The saturated water generated inside the water guide plate 3 overflows from the opening of the water guide plate 3, then descends along the outer surface 3c of the water guide plate 3 (see FIG. 1(a)), and is accumulated in the lower portion of the container 2. Thereafter, the saturated water accumulated in the lower portion of the container 2 is discharged from the open end 6a of the overflow pipe 6 as treated water (water treated inside the container 2) at a point in time when the water surface 7 reaches the predetermined height.

As described above, the saturated water generation device 1a can efficiently generate the water (saturated water) saturated with oxygen and sufficiently increase the dissolved oxygen concentration of water. In addition, the saturated water generation device 1a has a simple structure and can be manufactured at low cost. Furthermore, in the saturated water generation device 1a, the upper surface 2f of the container 2 is open, and the pressure of the gas phase formed in the container 2 is equal to the atmospheric pressure, and thus the container 2 does not need to have a pressure-resistant structure like a pressurizing tank 8 to be described later. This further reduces a manufacturing cost.

FIG. 2(b) is a front view of a saturated water generation device 1b according to a modification of the saturated water generation device 1a.

As illustrated in FIG. 2(b), the saturated water generation device 1b has a structure in which the distal end 5a of the water supply pipe 5 and one end of an air supply pipe 16 are inserted into the container 2 through a water supply port (not illustrated) and an air supply port (not illustrated) provided in an upper plate 2d that closes the upper surface 2f in the saturated water generation device 1a, and an exhaust pipe 17 is connected to an exhaust port (not illustrated) provided in the upper plate 2d, a compressor 18 is connected to the other end of the air supply pipe 16, and an electromagnetic valve 19a is installed in the exhaust pipe 17.

According to such a structure, since the upper surface 2f of the container 2 is closed, air whose pressure is made higher than an atmospheric pressure by the compressor 18 can be supplied into the container 2. As a result, a gas phase having a pressure higher than the atmospheric pressure is formed inside the container 2, and thus it is possible to generate treated water having a higher dissolved oxygen concentration than that in the saturated water generation device 1a in one pass by ejecting water from the nozzle 4 toward the inner surface 3b of the water guide plate 3 near the opening.

### Second Embodiment

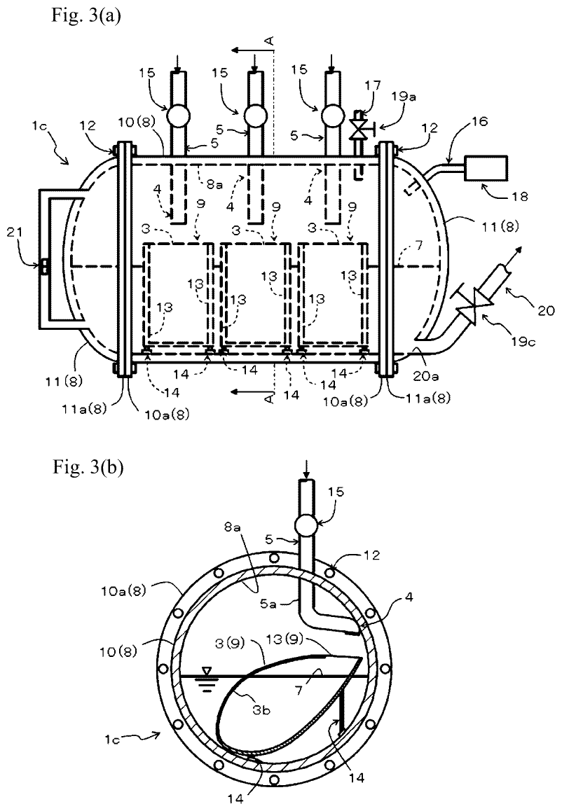

FIG. 3(a) is an external view of a saturated water generation device 1c according to a second embodiment of the present invention, and FIG. 3(b) is a cross-sectional view taken along line A-A in FIG. 3(a). Note that only some fastening members are denoted by reference signs in FIGS. 3(a) and 3(b) in order to avoid complication of the drawings. In addition, the components illustrated in FIGS. 1(a) and 1(b) are denoted by the same reference signs, and the description thereof is appropriately omitted.

As illustrated in FIGS. 3(a), 3(b), and 4(a), the saturated water generation device 1c includes three water guide members 9 installed in the pressurizing tank 8 in which a second drain port 20a through which treated water is discharged is provided in a lower portion and a gas phase is formed in an upper portion by air having a pressure higher than an atmospheric pressure. The pressurizing tank 8 includes a cylindrical tank main body 10 provided with flanges 10a at both ends and installed to be horizontal in the axial direction, and a pair of cover bodies 11 and 11 provided with flanges 11a, respectively, and has a structure in which the flange 10a of the tank main body 10 and the flange 11a of the cover body 11 are coupled using a fastening member 12 including a bolt and a nut.

The water guide member 9 includes the water guide plate 3 bent so as to have a shape in which an ovoid line in a side view is partially cut out, and a pair of side plates 13 and 13 closing both side surfaces of the water guide plate 3, and is coupled to a lower portion of a side surface 8a of the pressurizing tank 8 via a coupling tool 14 with the opening 9a (see FIG. 4(a)) facing upward.

The nozzles 4 ejecting water from above to the inner surfaces 3b (see FIG. 3(b)) of the water guide plates 3 near the openings 9a (see FIG. 4(a)) are connected to the distal ends 5a (see FIG. 3(b)) of three water supply pipes 5 inserted into the pressurizing tank 8 through water supply ports (not illustrated), respectively, provided in the upper portion of the pressurizing tank 8. In addition, discharge ports of the water supply pumps 15 are connected to proximal ends of the water supply pipes 5, and one ends of the air supply pipe 16 and the air exhaust pipe 17 are connected to an air supply port (not illustrated) and an air exhaust port (not illustrated), respectively, provided in an upper portion of the side surface 8a of the pressurizing tank 8. The compressor 18 is connected to the other end of the air supply pipe 16, and the electromagnetic valve 19a is installed in the exhaust pipe 17.

In addition, a drain pipe 20 in which the electromagnetic valve 19c is installed is connected to the second drain port 20a, and a water level sensor 21 for detecting an upper limit water level and a lower limit water level of water accumulated inside, and a control unit (not illustrated), which controls an operation of the compressor 18 and an opening degree of the electromagnetic valve 19a based on a detection result of the water level sensor 21, are installed on the cover bodies 11 of the pressurizing tank 8. That is, the saturated water generation device 1c has a structure in which a height of the water surface 7 is kept constant by controlling the amount of a gas supplied to the inside of the pressurizing tank 8 through the air supply pipe 16 and the amount of a gas discharged to the outside of the pressurizing tank 8 through the exhaust pipe 17 based on the water surface 7 inside the pressurizing tank 8 detected by the water level sensor 21.

In the saturated water generation device 1c, the water guide members 9 are disposed inside the pressurizing tank 8 instead of the container 2, which is different from the saturated water generation device 1b. Thus, the gas phase having a higher pressure than that in the saturated water generation device 1b can be easily formed inside the pressurizing tank 8 and in the upper portion of the water guide members 9. In this state, when water is ejected from the nozzles 4 toward the inner surfaces 3b near the openings 9a with respect to the water guide plates 3 of the water guide members 9, since the pressure of the gas phase is higher than that in the saturated water generation device 1b, treated water having a higher dissolved oxygen concentration than that in the saturated water generation device 1b can be generated in one pass. In addition, in the saturated water generation device 1c, an upper surface of the water guide member 9 is open, and a pressure of air present inside the water guide member 9 is equal to the pressure of air forming the gas phase in the upper portion of the pressurizing tank 8, and thus the water guide member 9 does not need to have a pressure-resistant structure similar to that of the pressurizing tank 8. That is, in the saturated water generation device 1c, the water guide member 9 may have a simple structure including the water guide plate 3 and the pair of side plates 13 and 13, and thus a manufacturing cost can be reduced.

FIG. 4(a) is an external perspective view of the water guide member 9, and FIG. 4(b) is an external perspective view of a modification of the water guide member 9. In addition, FIG. 4(c) is a cross-sectional view taken along line B-B in FIG. 4(b).

As illustrated in FIG. 4(a), the saturated water generation device 1c has a structure including the water guide member 9 that includes the water guide plate 3 and the pair of side plates 13 and 13 and has the opening 9a formed by a portion surrounded by the pair of ends 3a, 3a (see FIG. 1(a)) and the pair of side plates 13 and 13, but the saturated water generation device 1c is not limited to such a structure. For example, as illustrated in FIGS. 4(b) and 4(c), the saturated water generation device 1c may have a structure including a block-shaped water guide member 22 having a cavity 23 that has an inner surface 23b whose contour line has a shape in which an ovoid line is partially cut out in a side view of the inner surface 23b continuous with an opening 23a. In this case, the contour line of the inner surface 23b of the cavity 23 in the water guide member 22 corresponds to a contour line of the inner surface 3b continuous with the opening 9a in the water guide plate 3 of the water guide member 9.

Note that not only the saturated water generation device 1c but also the saturated water generation device 1a and the saturated water generation device 1b can have the structure in which the water guide member 22 is installed inside the container 2 instead of the water guide plate 3. However, when the water guide member 9 including the water guide plate 3 is used instead of the water guide member 22, there is an advantage that the manufacturing cost is reduced since the structure is simple and a processing cost is low.

### Third Embodiment

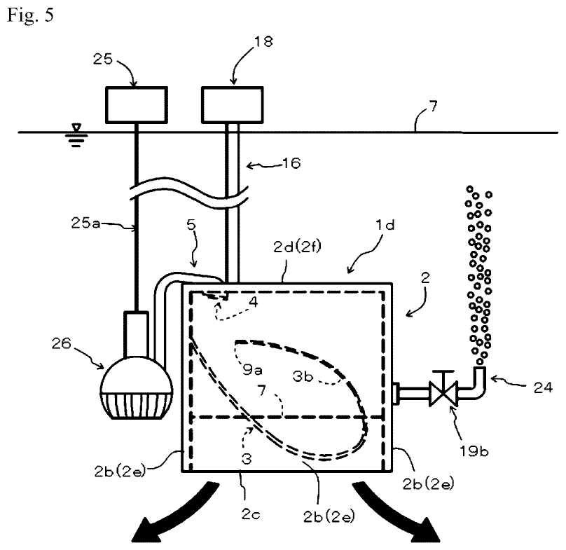

FIG. 5 is an external view of a saturated water generation device 1d according to a third embodiment of the present invention. Note that the components illustrated in FIGS. 1(a) and 1(b) and FIGS. 3(a) and 3(b) are denoted by the same reference signs, and the description thereof is appropriately omitted.

As illustrated in FIG. 5, the saturated water generation device 1d is provided with an exhaust pipe 24 in which an electromagnetic valve 19b is interposed with respect to the side plate 2b of the container 2 installed such that at least a part thereof is immersed in water with the bottom surface 2c being open, and a water supply port (not illustrated) and an air supply port (not illustrated) provided on the upper plate 2d that closes the upper surface 2f of the container 2, instead of the first drain port (not illustrated) and the overflow pipe 6 provided in the saturated water generation device 1a. The distal end 5a (see FIG. 2(b)) of the water supply pipe 5 is inserted into the container 2 through the water supply port, and the compressor 18 is connected to the other end of the air supply pipe 16 having one end connected to the air supply port. In addition, a proximal end of the water supply pipe 5 is connected to a discharge port of a submersible pump 26 to which power is supplied from an AC power source 25 via a power cable 25a, and the nozzle 4 ejecting water from above to the inner surface 3b of the water guide plate 3 near the opening 9a is connected to the distal end 5a (see FIG. 2(b)) of the water supply pipe 5. If a pipe that branches from the air supply pipe 16 and leads to a cavity of a rotation mechanism of a motor of the submersible pump 26 is provided to send air whose pressure is increased by the compressor 18 to the cavity through the pipe, it is possible to prevent a situation in which surrounding water enters the cavity to break the motor. In this case, the submersible pump 26 does not need to be an expensive pump having pressure resistance, and thus a general-purpose pump having an inexpensive structure can be used as the submersible pump 26.

In the saturated water generation device 1d, when air adjusted to a pressure higher than an atmospheric pressure by the compressor 18 in a state where the inside of the container 2 is filled with water is supplied from the air supply pipe 16 to the inside of the container 2, some of the water is pushed out from the bottom surface 2c, and a gas-liquid boundary surface (the water surface 7) moves downward. As a result, a gas phase is formed in an upper portion of the container 2.

At this time, when the electromagnetic valve 19b is opened, air supplied from the air supply pipe 16 to the container 2 is discharged to the outside of the container 2 through the exhaust pipe 24 at a point in time when the gas-liquid boundary surface reaches an exhaust port (not illustrated) to which the exhaust pipe 24 is connected, and thus the gas-liquid boundary surface does not move downward and remains at a position of the exhaust port (not illustrated) to which the exhaust pipe 24 is connected. As a result, a pressure of the gas phase formed inside the container 2 is kept constant in a state of being higher than the atmospheric pressure. For example, in a case where a depth from the water surface 7 to the exhaust port (not illustrated) to which the exhaust pipe 24 is connected is 3 m, the pressure of the gas phase described above is about 30 kPa (gauge pressure).

As described above, the pressure of the gas phase formed inside the container 2 in the saturated water generation device 1d changes by changing a depth of water at which the container 2 is installed, and thus it is not necessary to install a control mechanism or the like for maintaining the gas phase at the constant pressure. In addition, since a position of the gas-liquid boundary surface is determined by the position of the exhaust port with respect to the container 2, a sensor for detecting the position of the gas-liquid boundary surface is also unnecessary. This reduces a manufacturing cost. Furthermore, in the saturated water generation device 1d, when air is continuously supplied from the air supply pipe 16 to the inside of the container 2 in a state where the exhaust port is open, excess air is discharged from the exhaust port so that the air inside the container 2 is constantly exchanged. As a result, a gas phase composition inside the container 2 is kept constant, and thus a dissolved oxygen concentration of treated water discharged from the container 2 is less likely to vary. In addition, since the bottom surface 2c of the container 2 is open and the same water pressure is applied to the container 2 from the inside and the outside, the container 2 does not need to have a pressure-resistant structure. Therefore, the saturated water generation device 1d has an advantage that the manufacturing cost is reduced as compared with the case of the saturated water generation device 1b.

### Fourth Embodiment

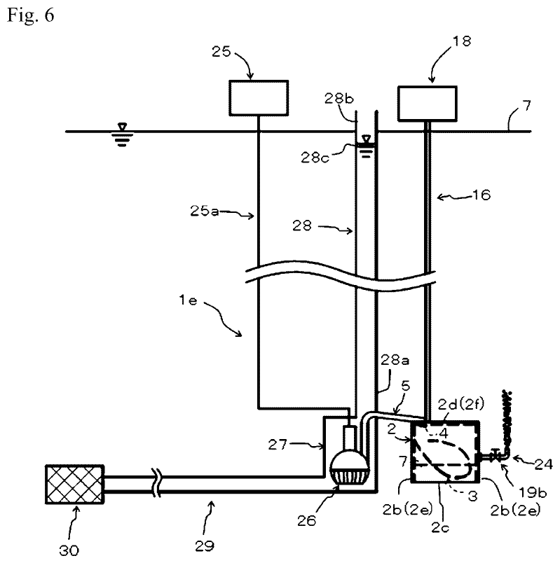

FIG. 6 is an external view of a saturated water generation device 1e according to a fourth embodiment of the present invention. Note that the components illustrated in FIGS. 1(a) and 1(b), FIGS. 3(a) and 3(b), and FIG. 5 are denoted by the same reference signs, and the description thereof is appropriately omitted.

As illustrated in FIG. 6, the saturated water generation device 1e has a structure that includes a pump pressurizing tank 27 in which the submersible pump 26 is housed, a first water supply channel 28 which is parallel to the vertical direction and is installed in water in a state where the pump pressurizing tank 27 is connected to a lower end 28a and an upper end 28b is open, a second water supply channel 29 which is installed in water to be parallel to the horizontal direction and has one end to which the pump pressurizing tank 27 is connected, and a strainer 30 connected to the other end of the second water supply channel 29, in addition to the saturated water generation device 1d.

In the saturated water generation device 1e, when water is supplied to the inside of the container 2 through the water supply pipe 5 by operating the submersible pump 26, the inside of the pump pressurizing tank 27 becomes a negative pressure, so that water inside the first water supply channel 28 moves downward and water inside the second water supply channel 29 moves toward the pump pressurizing tank 27. When the water inside the second water supply channel 29 moves, water around the strainer 30 is sucked into the second water supply channel 29.

In a case where one end of a pipe for water supply having the other end to which the strainer 30 is attached as in the second water supply channel 29 is connected to a suction port (not illustrated) of the submersible pump 26, a range in which the strainer 30 can be installed is determined by a suction capacity of the submersible pump 26. For example, when the suction capacity of the submersible pump 26 is low, the strainer 30 needs to be installed near the submersible pump 26. On the other hand, in the saturated water generation device 1e having the above structure, the water inside the second water supply channel 29 moves toward the pump pressurizing tank 27 as the water inside the pump pressurizing tank 27 is sucked by the submersible pump 26, and as a result, the water around the strainer 30 is sucked into the second water supply channel 29. That is, when the water inside the pump pressurizing tank 27 is sucked by the submersible pump 26, the water around the strainer 30 is sucked into the second water supply channel 29 regardless of the suction capacity of the submersible pump 26 even if the strainer 30 is installed at a place away from the submersible pump 26, so that the submersible pump 26 does not need a high suction capacity. Therefore, in the saturated water generation device 1e, for example, the strainer 30 can be installed at a place away from the submersible pump 26 even when the suction capacity of the submersible pump 26 is low.

As described above, in a case where the pump pressurizing tank 27 and the second water supply channel 29 in the saturated water generation device 1e are installed in a benthic region of a pond, a swamp, or the like, the strainer 30 is installed at a position away from the submersible pump 26 regardless of the suction capacity of the submersible pump 26, so that a wide range of water can be treated. At this time, if the container 2 is installed at the same height as the strainer 30, a temperature difference between bottom water sucked into the second water supply channel 29 from the strainer 30 and treated water discharged from the container 2 is small, and the treated water is hardly mixed with intermediate water and upper water, so that only the water in a bottom water zone can be treated. In addition, a water surface 28c inside the first water supply channel 28 is lower than the surrounding water surface 7 during the operation of the submersible pump 26. Thus, in the saturated water generation device 1e, it is possible to easily check an operating condition of the submersible pump 26 installed near a benthic region of a lake, a swamp, or the like by visually checking a height of the water surface 28c.

Although FIG. 6 illustrates the container 2 constituting the saturated water generation device 1d illustrated in FIG. 5 as the container 2 constituting the saturated water generation device 1e, the container 2 constituting the saturated water generation device 1b illustrated in FIG. 2(b) can also be used as the container 2 of the saturated water generation device 1e.

Table 1 shows a saturated amount of oxygen dissolved in distilled water at 1 atm for each temperature. However, a column represents a decimal part of the temperature, and a row represents an integer part of the temperature. For example, a saturated amount of dissolved oxygen (unit: mg/L) when the temperature of distilled water is 9.2° C. is a value (11.14) described in a section where a row of 9 and a column of 0.2 intersect. Note that a saturated amount of dissolved oxygen when a pressure of oxygen in contact with distilled water is 1.04 atm (corresponding to a depth of water of 0.4 m) is obtained by multiplying 11.14 by 1.04.

Table 2 shows the pressure of oxygen, the depth of water and temperature (unit: ° C.) at which the pressure is generated, and theoretical values of the saturated amount of dissolved oxygen (DO value in a unit of mg/L). In addition, actual measurement values in the table indicate results obtained by measuring the amount of dissolved oxygen (DO value in a unit of mg/L) in treated water while changing a pressure of air ejected from the nozzle 4 in the saturated water generation device 1b. Note that tap water is used instead of distilled water in the experiment.

TABLE 1

| | 0.0 | 0.1 | 0.2 | 0.3 | 0.4 | 0.5 | 0.6 | 0.7 | 0.8 | 0.9 |
|---|---|---|---|---|---|---|---|---|---|---|
| 7 | 11.75 | 11.73 | 11.70 | 11.67 | 11.64 | 11.61 | 11.58 | 11.55 | 11.52 | 11.50 |
| 8 | 11.47 | 11.44 | 11.41 | 11.38 | 11.36 | 11.33 | 11.30 | 11.27 | 11.25 | 11.22 |
| 9 | 11.19 | 11.16 | 11.14 | 11.11 | 11.08 | 11.06 | 11.03 | 11.00 | 10.98 | 10.95 |

TABLE 2

| | | | | | |
|---|---|---|---|---|---|
| Depth of water | 0.4 | 1.0 | 2.0 | 3.0 | 3.5 |
| Temperature | 9.2 | 8.1 | 8.0 | 7.6 | 7.3 |
| Air pressure | 1.04 | 1.1 | 1.2 | 1.3 | 1.35 |
| Theoretical value | 11.58 | 12.58 | 13.76 | 15.05 | 15.75 |
| Actual measurement value | 11.94 | 12.66 | 13.33 | 14.44 | 15.45 |

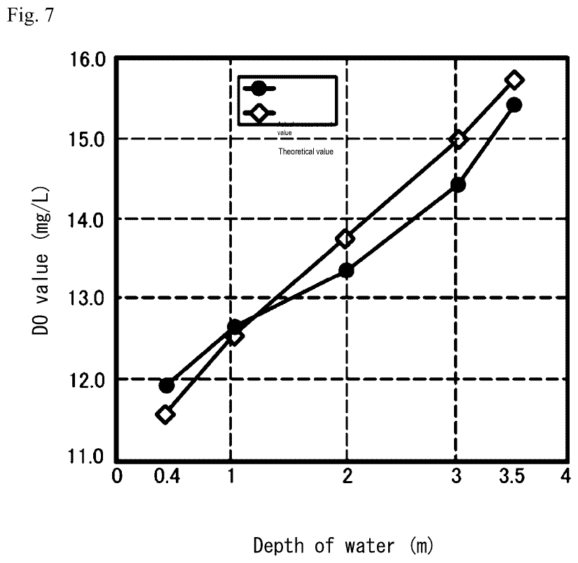

FIG. 7 is a graph in which the theoretical values and the actual measurement values shown in Table 2 are plotted for each depth of water. However, the horizontal axis represents the depth of water, and the vertical axis represents the DO value (unit: mg/L). In addition, black circles indicate the actual measurement values, and white diamonds indicate the theoretical values.

FIG. 7 illustrates that the saturated water generation device 1b generates saturated water corresponding to an air pressure only by supplying air adjusted to the air pressure under a desired depth of water into the container 2 without using a pure oxygen gas. In this case, since it is not necessary to use the pure oxygen gas, a cost required for generating saturated water is reduced. That is, according to the saturated water generation device 1b, the saturated water corresponding to the air pressure under the desired depth of water can be easily and inexpensively generated. Note that such an effect in the saturated water generation device 1b is similarly exhibited in the saturated water generation devices 1c to 1e capable of adjusting a pressure of air inside the water guide member 9 to a pressure higher than an atmospheric pressure.

### INDUSTRIAL APPLICABILITY

The present invention is applicable to a case where water is purified by increasing the amount (DO value) of oxygen dissolved in water in a lake, a marsh, an aquaculture farm of seafood, a sewage treatment plant, or the like.

### REFERENCE SIGNS LIST

1a to 1e saturated water generation device
2 container
2a bottom plate
2b side plate
2c bottom surface
2d upper plate
2e side surface
2f upper surface
3 water guide plate
3a end
3b inner surface
3c outer surface
4 nozzle
5 water supply pipe
5a distal end
6 overflow pipe
6a open end
7 water surface
8 pressurizing tank
8a side surface
9 water guide member
9a opening
10 tank main body
10a flange
11 cover body
11a flange
12 fastening member
13 side plate
14 coupling tool
15 water supply pump
16 air supply pipe
17 exhaust pipe
18 compressor
19a to 19c electromagnetic valve
20 drain pipe
20a second drain port
21 water level sensor
22 water guide member
23 cavity
23a opening
23b inner surface
24 exhaust pipe
25 AC power source
25a power cable
26 submersible pump
27 pump pressurizing tank
28 first water supply channel
28a lower end
28b upper end
28c water surface
29 second water supply channel
30 strainer

1. A saturated water generation device comprising:
a container in which a bottom surface and a side surface are closed, a first drain port through which treated water is discharged is provided in a lower portion, and a gas phase is formed in an upper portion by a gas containing at least oxygen;
a water guide member that is installed in the container with an opening facing upward and has an inner surface whose contour line has a shape in which an ovoid line is partially cut out in a side view of the inner surface continuous with the opening;
a nozzle configured to eject water from above to the inner surface near the opening;
a water supply pipe having a distal end to which the nozzle is connected; and
a water supply pump having a discharge port connected to a proximal end of the water supply pipe,
wherein the treated water is stored in the lower portion of the container.

2. The saturated water generation device according to claim 1, further comprising:
an air supply pipe configured to supply the gas into the container; and
a compressor connected to a proximal end of the air supply pipe,
wherein the container has an upper surface being closed, and a water supply port, an air supply port, and an openable and closable exhaust port provided in the upper portion, and
the distal end of the water supply pipe and a distal end of the air supply pipe are inserted into the container through the water supply port and the air supply port, respectively.

3. The saturated water generation device according to claim 2, wherein
the container is installed to be at least partially immersed in water and has the bottom surface being open instead of being provided with the first drain port, and
the water supply pump is a submersible pump.

4. The saturated water generation device according to claim 3, further comprising:
a pump pressurizing tank in which the submersible pump is housed;
a first water supply channel installed in the water to be parallel to a vertical direction and having a lower end to which the pump pressurizing tank is connected and an upper end being open;
a second water supply channel installed in the water to be parallel to a horizontal direction and having one end to which the pump pressurizing tank is connected; and
a strainer connected to another end of the second water supply channel.

5. The saturated water generation device according to claim 1, wherein the water guide member includes a bent plate material.

6. The saturated water generation device according to claim 1, further comprising:
a pressurizing tank in which a second drain port through which treated water is discharged is provided in a lower portion and a gas phase is formed in an upper portion by the gas containing at least oxygen and having a pressure higher than an atmospheric pressure, the pressurizing tank being provided instead of the container;
an air supply pipe configured to supply the gas into the pressurizing tank;
a compressor connected to the air supply pipe; and
a drain pipe that is connected to the second drain port and configured to discharge the treated water accumulated in the pressurizing tank,
wherein the water guide member is installed in the pressurizing tank with the opening facing upward.

7. The saturated water generation device according to claim 6, wherein the water guide member includes a bent plate material and a pair of side plates that closes both side surfaces of the plate material.

8. The saturated water generation device according to claim 2, wherein the water guide member includes a bent plate material.

9. The saturated water generation device according to claim 3, wherein the water guide member includes a bent plate material.

10. The saturated water generation device according to claim 4, wherein the water guide member includes a bent plate material.
